(19) United States
(12) Patent Application Publication
(10) Pub. No.: US 2011/0221715 A1
(43) Pub. Date: Sep. 15, 2011

(54) FLAT PANEL DISPLAY DEVICE AND METHOD FOR DRIVING THEREOF

(75) Inventors: Jin-Wook Yang, Yongin-city (KR); Sang-Jae Yeo, Yongin-city (KR); Sang-Hoon Lee, Yongin-city (KR)

(73) Assignee: Samsung Mobile Display Co., Ltd., Yongin-city (KR)

(21) Appl. No.: 13/037,590

(22) Filed: Mar. 1, 2011

(30) Foreign Application Priority Data
Mar. 10, 2010 (KR) 10-2010-0021264

(51) Int. Cl. G06F 3/038; G02F 1/133; G02F 1/1368; G09G 3/36

(52) U.S. Cl. 345/204; 349/33; 349/43; 345/87

(57) ABSTRACT

A flat panel display device is disclosed. In some embodiments, the flat panel display device has parallel gate and data lines in a display area. In some embodiments, all sub-pixels of each pixel are connected to the same data line and are connected to the same gate line.

### CROSS-REFERENCE TO RELATED APPLICATIONS

This application claims priority to and the benefit of Korean Patent Application No. 10-2010-0021264, filed on Mar. 10, 2010, in the Korean Intellectual Property Office, the entire content of which is incorporated herein by reference.

### BACKGROUND

1. Field

The disclosed technology relates to a flat panel display device, and more particularly, to a flat panel display device and a method for driving thereof.

2. Description of the Related Technology

The flat panel display device is becoming extremely important for mass communication of visual information and for the development of information technology (IT). Accordingly, low power consumption, reduced size, reduced weight, high resolution, and the like for further improving the competitiveness of the flat panel display device are desirable.

A flat panel liquid crystal display device (LCD device) uses optical anisotropy of the liquid crystal. Advantages of the liquid crystal display device include small size, low power consumption, and high resolution.

A liquid crystal display device individually supplies image information to pixels arranged, for example, as a matrix, and can display the desired image by controlling light transmittance of the pixels. Therefore, the liquid crystal display device includes a liquid crystal panel, and a driver for driving the liquid crystal panel.

FIG. 1 is a diagram showing a structure of liquid crystal display (LCD) device 100 having some features found in conventional LCD devices.

With reference to FIG. 1, the liquid crystal display device 100 includes the liquid crystal panel 110, which includes an image display region 112. In the display region 112, each pixel 120 is arranged near intersections of gate lines G1-Gn and data lines D1-Dm.

The liquid crystal panel 110 includes non-display region 114, which has gate link lines GL1-GLn and data link lines DL1-DLm. The gate link lines GL1-GLn and data link lines DL1-DLm are disposed outside of the image display region 112 and are respectively connected to a plurality of gate lines G1-Gn and a plurality of data lines D1-Dm. The LCD device 100 includes a driver 130, which supplies a scan signal to the pixels 120 through a plurality of gate lines GL1-GLn, supplies the image signal to the pixels 120 through a plurality of data link lines DL1-DLm, and drives the pixels.

The driver 130 is disposed in the non-display region 114 of the liquid crystal panel 110 as depicted in the figure as a single element or chip. However, the driver 130 can be alternatively implemented as multiple elements, such as a gate driver and a data driver.

The pixels 120 disposed in the image display region 112 are respectively formed near intersections of the data lines D1-Dm arranged in a first direction (a vertical direction) and the gate lines G1-Gn arranged in a second direction (a horizontal direction).

In addition, the data lines are connected to the data link lines DL1-DLm, which generally extend in the same direction (a first direction) in the non-pixel region 114, and the gate lines are also connected to the gate link lines GL1-GLn, which generally extend in the same direction (the first direction) in the non-pixel region 114.

The gate link lines GL1-GLn and the data link lines DL1-DLm are connected to the gate lines G1-Gn and the data lines D1-Dm, which connect to the driver 130 and in the image display region 112. The gate link lines GL1-GLn are respectively connected to the gate lines G1-Gn, and extend in both the first direction and the second direction on the side of the image display region 112. Therefore, there is a disadvantage that some width of the non-display region 114 is used for the gate link lines GL1-GLn. This use of the non-display region 114 for the gate link lines GL1-GLn conflicts with the need for reduced LCD device size.

### SUMMARY OF CERTAIN INVENTIVE ASPECTS

One inventive aspect is a flat panel display device, including a display panel, which has gate lines and data lines that are arranged in a first direction and plurality of pixels connected to the gate lines and the data lines. The display device also has a driver configured to drive the pixels by supplying scan signals to the gate lines and image data signals to the data lines, and a plurality of gate link lines and data link lines between the gate lines and the data lines, and the driver, where the gate link lines are connected to the gate lines and the data link lines are connected to the data lines.

Another inventive aspect is a method of driving a flat panel display device including first, second, and third pixels sharing one data line and one gate line. The method includes supplying a scan signal to the gate line during a first horizontal period, supplying first data from the data line to the first pixel by supplying a first control signal to a first control line connected to the first pixel during a first period of the first horizontal period, supplying second data from the data line to the second pixel by supplying a second control signal to a second control line connected to the second pixel during a second period of the first horizontal period, and supplying third data from the data line to the third pixel for the rest period of the first horizontal period.

Another inventive aspect is a flat panel display device, including a plurality of pixels, each including a plurality of sub-pixels. The display device also includes a plurality of gate lines connected to the pixels, where each of the sub-pixels of each of the pixels are connected to the same gate line, and a plurality of data lines connected to the pixels, where each of the sub-pixels of each of the pixels are connected to the same data line.

### BRIEF DESCRIPTION OF THE DRAWINGS

The accompanying drawings illustrate exemplary embodiments, and, together with the description, serve to explain various innovative aspects.

FIG. 1 is a block diagram illustrating a liquid crystal display device;

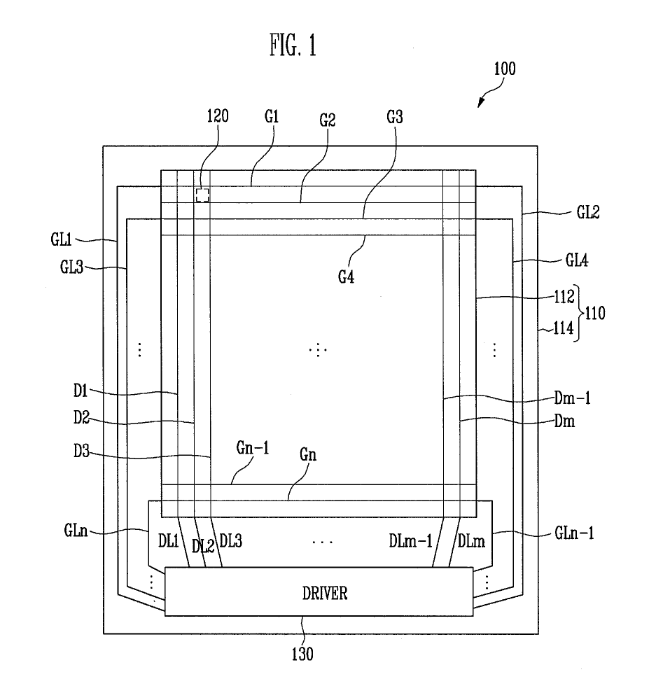

FIG. 2 is a block diagram illustrating a configuration of a flat panel display device according to one embodiment;

FIG. 3 is a circuit view showing one region of the display panel of FIG. 2; and

FIG. 4 is a timing diagram illustrating signals that implement image motion.

### DETAILED DESCRIPTION OF CERTAIN INVENTIVE EMBODIMENTS

Hereinafter, certain exemplary embodiments are described with reference to the accompanying drawings. When a first element is described as being coupled to a second element, the first element may be directly coupled to the second element or may be indirectly coupled to the second element via a third element. Further, some of the elements that are not essential to the complete understanding of the invention are omitted for clarity. Also, like reference numerals generally refer to like elements throughout.

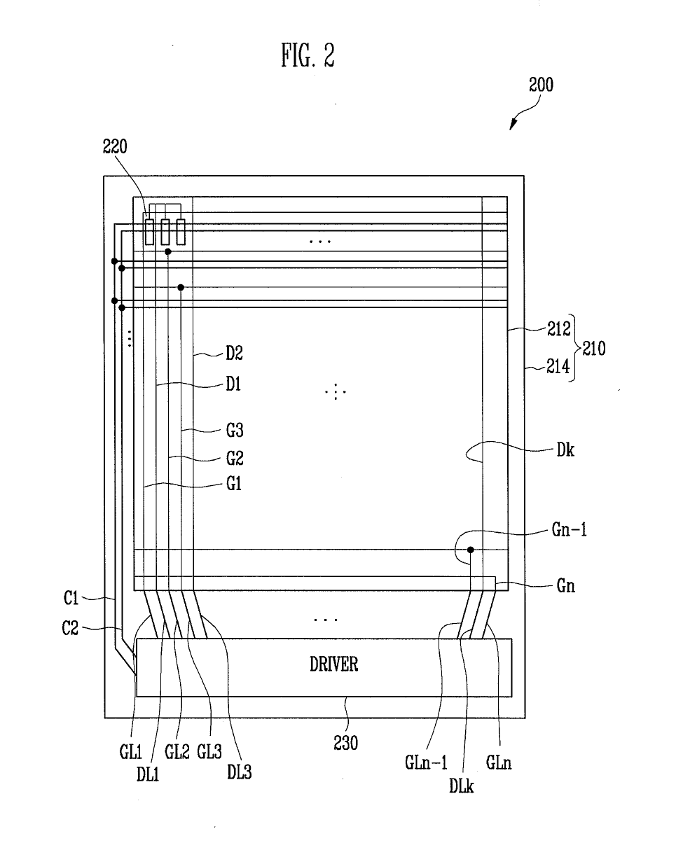

FIG. 2 is a block diagram illustrating a configuration of a flat panel display device 200 according to some embodiments.

With reference to FIG. 2, the flat panel display device 200 includes display panel 210, which has gate lines G1-Gn and data lines D1-Dk. The gate lines G1-Gn and data lines D1-Dk are arranged in the same direction and are substantially parallel in the display region 212. The flat panel display panel 210 also includes a plurality of pixels 220 each connected to the gate lines G1-Gn and the data lines D1-D3/m. The flat panel display device 200 also includes a driver 230 for driving the pixels by supplying image signals to the pixels 210 through the data lines and scan signals to the gate lines.

The driver 230 can be implemented as a single chip or element, as shown, and may alternatively be implemented as multiple elements or chips, such as a gate driver for driving the gate lines and a data driver for driving the data lines.

The driver 230 supplies signals to the gate lines G1-Gn and the data lines D1-Dk through the gate link lines GL1-GLn and the data link lines DL1-DLk, respectively.

The display panel 210 includes the image display region 212, which includes the gate lines G1-Gn, the data lines D1-Dk, and the plurality of pixels. The display panel 210 also includes the non-display region 214, which is disposed in the outside of the image display region 212 and includes the gate link lines GL1-GLm and the data link lines DL1-DLk that are connected to the plurality of the gate lines and the data lines, respectively. In some embodiments, the image display region 212 is defined by a contiguous area bounded by a perimeter intersecting outer points or edges of outermost pixels.

A beneficial aspect of the display device 200 is that the width of the non-display region 214 on the side of the image display region 212 is minimized. In some embodiments, the non-display region 214 is essentially only on the bottom of the image display region 212.

In some embodiments, there are no gate lines G1-Gn or data lines D1-Dk on sides of the image display region 212 which do not have the driver 130. Therefore, the non-display region 214 disposed in the side of the image display region is not used or is minimal.

In some embodiments, when driving the each pixel 220, control lines C1 and C2 may be used. In some embodiments, the control lines C1 and C2 are in the non-display region 214 on the side of the image display region 212. In other embodiments, the control lines are in the display region 212, and are not in the non-display region 214 on the sides of the image display region 212 which do not have the driver 130.

In some embodiments, there are only two control lines C1 and C2. In such embodiments, the control lines C1 and C2 are much fewer in number as than the gate link lines GL1-GL2. Therefore, even though the control lines C1 and C2 are disposed in the non-display region 214, the non-display region is small compared to devices having the gate link lines GL1-GL2 in the non-display region 214.

According to the disclosed structure, the image display region 212 can be maximized by removing or minimizing the non-display region 214 on the sides of the image display region 212 which do not have the driver 130.

The disclosed structure may be used in any flat panel display devices, and may be particularly advantageous to those which use active matrix addressing. For example, the structure can be used in a liquid crystal display device, an organic electroluminescence display device, and the like, but the liquid crystal display device will be described as an example hereafter.

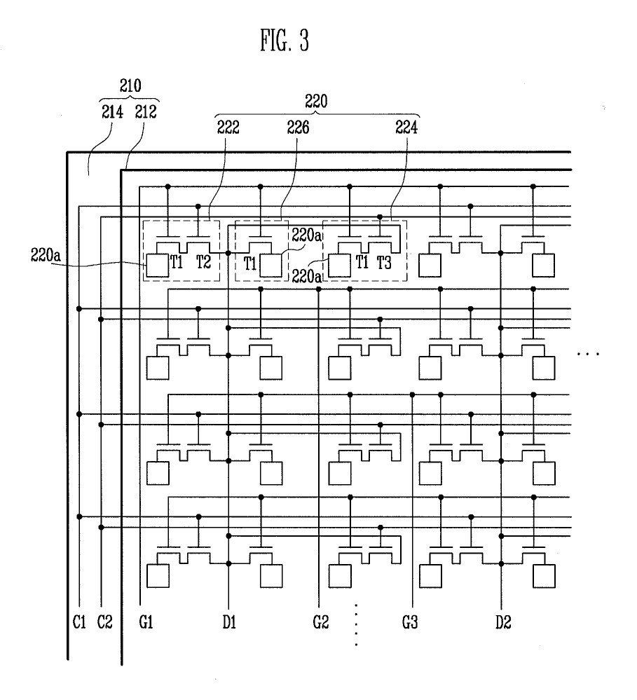

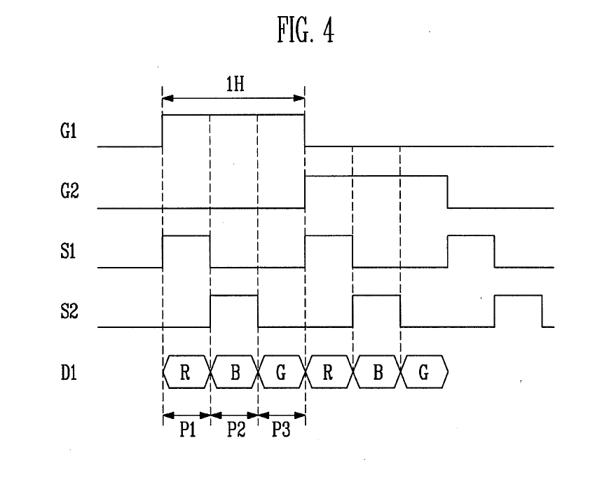

FIG. 3 is a schematic view showing one portion of a display panel as depicted in FIG. 2, and FIG. 4 is a timing diagram illustrating signals that implement image motion.

With reference to FIG. 3, the illustrated portion of image display region 212 of the display panel 220 includes data lines D1 and D2 and gate lines G1, G2, and G3, a plurality of pixels 220 connected to the data lines and the gate lines.

In this embodiment, red (R), green (G), and blue (B) pixels 222, 224, and 226 cooperatively form a pixel 220. Accordingly, the red (R), green (G), and blue (B) pixels 222, 224, and 226 each form a sub-pixel of pixel 220. In some embodiments, another number of sub-pixels are used to for the pixels 220. Each of the red (R), the green (G) and the blue (B) pixels 222, 224, and 226 are connected to the same data line. As a result, the required line number of data lines is reduced by ⅔.

As an example, each pixel in a row conventionally requires a dedicated data line. However, using the disclosed structure, because three pixels share each data line, only one third of the number of data lines are used. For example, in the case of WVGA resolution 864*3=2592 data lines are used. However, using the disclosed structure, because three pixels share one data line, only 864 data lines are used.

As shown in FIG. 3, because three pixels share each data line, there is space between pixels for the vertical portions of the gate lines. In this embodiment, both the horizontal and vertical portions of the gate lines are arranged in the space between the pixels.

With reference to FIG. 3, the first gate line G1 has a vertical portion arranged in the first direction parallel to the first data line D1, and has a horizontal portion arranged in the second direction along the first row in order to connect to the pixels disposed in the first row.

Likewise, each of the second and third gate lines G2 and G3 also have a vertical portion arranged in the first direction parallel to the first data line D1, and have a horizontal portion arranged in the second direction along the second and third rows, respectively.

Unlike the first gate line G1, the vertical portions of the second and third gate lines G2 and G3 connect to the respective horizontal portions in a central portion of the horizontal portions. In contrast, the vertical portion of the first gate line G1 connects to the end of the horizontal portion of the first gate line G1.

In order for the data to be provided to each of the R, G, and B pixels sharing the same data line, the image data is sequentially applied to the shared data line during each horizontal time 1H. During the sequential application of the image data, the control lines C1 and C2 are used to select which of the R, G, and B pixels receives the applied image data. To select the R, G, and B pixels, the control lines control the state of switching elements T2 and T3.

An embodiment of a pixel structure is described with reference to FIG. 3. As shown, the first data line D1 is connected to the first to third pixels 222, 224, and 226 which are arranged in the first row.

With reference to FIG. 3, the first to third pixels 222, 224, 226 each include a light control element 220a, such as a liquid crystal cell and at least one switching element connected to the liquid crystal cell 220a.

In this embodiment, the first to third pixels 222, 224, 226 are aligned along the first row, and are connected to the first gate line G1.

The first pixel 222 further includes second switching element T2 in addition to a first switching element T1. The first switching element T1 of the first pixel 222 and the second switching element T2 supply the image signal to the liquid crystal cell 220a of the first pixel 222 from the first data line D1. The image signal is supplied if the switching element T1 of the first pixel 222 is turned on by the scan signal supplied through the first gate line G1 and if the second switching element T2 is turned on by the first control signal supplied to the first control line C1.

Accordingly, for the first pixel 222, even though the scan signal is supplied to the first gate line G1 connected to the first pixel 222, if the first control signal is not supplied to the first control line C1, the image signal is not supplied to the liquid crystal cell 220a. Therefore, for the first pixel 222, only when both the scan signal and the first control signal C1 are respectively supplied to the first and second switching elements T1 and T2, the image signal from the data line is supplied to the liquid crystal cell 220a of the first pixel 222.

Likewise, the second pixel 224 further includes third switching element T3 in addition to a first switching element T1. The first switching element T1 of the second pixel 224 and the third switching element T3 supply the image signal to the liquid crystal cell 220a of the second pixel 224 from the first data line D1. The image signal is supplied if the switching element T1 of the second pixel 224 is turned on by the scan signal supplied through the first gate line G1 and if the third switching element T3 is turned on by the first control signal supplied to the second control line C2.

Accordingly, for the second pixel 224, even though the scan signal is supplied to the gate line G1 connected to the second pixel 224, if the second control signal is not be supplied to the second control line C2, the image signal is not supplied to the liquid crystal cell 220a. Therefore, for the second pixel 224, only when both the scan signal and the second control signal C2 are respectively supplied to the first and third switching elements T1 and T3, the image signal from the data line is supplied to the liquid crystal cell of the second pixel 224.

As shown, the third pixel 226 includes first switching element T1 and does not include a switching element corresponding to the second and third switching elements of the first and second pixels 222 and 224, respectively. The first switching element T1 of the third pixel 226 supplies the image signal from the first data line D1 to the liquid crystal cell 220a of the third pixel 226 if turned on by the scan signal supplied to the first gate line G1.

The switching elements T1, T2, T3 may be implemented as thin film transistors, such as the N-type transistors discussed below. Other types of switching elements and transistors may be used.

As shown in FIG. 3, the first and second control lines C1 and C2 each have a vertical and a horizontal portion. In this embodiment, the horizontal portions of the first and second control lines C1 and C2 lines are in the space between the pixels in the image display region 212, however the vertical portions of the first and second control lines C1 and C2 lines are in the non-display region 214 on the side of the image display region 212. In some embodiments, the vertical portions of the first and second control lines C1 and C2 lines are in the image display region 212.

According to the embodiment of FIG. 3, the first, second and third pixels 222, 224, 226 are respectively implemented as red, blue, and green pixels, and the first and second pixels 222, 224 include the second and third switching elements T2, T3. However, this arrangement is only one example of many and embodiments are not limited thereto. Any two pixels of the red, the green, and the blue pixels can include the second and third switching element and the third pixel may be driven last of the three pixels in each horizontal period.

In this embodiment, the first to third pixels 222, 224, 226 are aligned along the first row, and are connected to the first gate line G1.

As shown in FIG. 3, the pixels which are connected to the first data line D1 and arranged in the second row are aligned along the second row, and are connected to the second gate line G2.

As shown, the second gate line G2 is implemented in a T-shaped bending shape in order to connect with the pixels arranged in the second row. The third gate line G3 and other gate lines are similarly implemented.

A method for driving the flat panel display device is described with reference to FIG. 3 and FIG. 4. The method is described for the first data line, and the three pixels arranged in the first row and connected to the first gate line and also the three pixels arranged in the second row and connected to the second gate line.

As shown in FIG. 4 a scan signal of a high level is supplied to the first gate line G1 for the first horizontal period 1H. The red, the blue, and the green data are sequentially applied to the data line D1 during the first horizontal period 1H.

During the first period P1 of the horizontal period1H, in order to turn on the second switching element T2 in the first pixel (the red pixel) 222, the first control signal C1 of a high level is supplied and the second control signal C2 of a low level is supplied.

Accordingly, the scan signal and the first control signal C1 are both supplied for the first period P1, so that the red data from the data line D1 is supplied to the liquid crystal cell 220a of the first pixel 222 via the first and second switching element T1 and T2 of the first pixel 222.

During the second period P2 of the horizontal period 1H, in order to turn on the third switching element T3 in the second pixel (the blue pixel) 224, the first control signal C1 of a low level is supplied and the second control signal C2 of a high level is supplied.

Accordingly, the scan signal and the second control signal C2 are both supplied for the second period P2, so that the blue data from the data line is supplied to the liquid crystal cell 220a of the second pixel 224 via the first and third switching elements T1 and T3 of the second pixel 224.

During the third period P3 of the horizontal period 1H, the first and second control signals C1 and C2 of a low level are supplied, and the green data is supplied to the third pixel (the green pixel) 226.

According to the disclosed method, the red data and the blue data are supplied to the third pixel (the green pixel) 226 during the first and second periods P1 and P2. Because the red and blue data are only briefly applied to the green pixel 226, no perceptible visual artifact is generated. In some embodiments, the red and blue data are applied to the green pixel for only about 2-3 us, whereas after the application of the data, the image is shown for about 16 ms.

As shown in FIG. 4, the pixels of the second row are similarly driven. While certain aspects have been described in connection with exemplary embodiments, it is to be understood that various modifications and equivalent arrangements are contemplated.

What is claimed is:

1. A flat panel display device, comprising:
a display panel including gate lines and data lines that are arranged in a first direction, and a plurality of pixels connected to the gate lines and the data lines;
a driver configured to drive the pixels by supplying scan signals to the gate lines and image data signals to the data lines; and
a plurality of gate link lines and data link lines between the gate lines and the data lines, and the driver, wherein the gate link lines are connected to the gate lines and the data link lines are connected to the data lines.

2. The flat panel display device as claimed in claim 1, wherein the pixels are arranged so that three pixels share one data line.

3. The flat panel display device as claimed in claim 2, wherein the three pixels include a red pixel, a green pixel, and a blue pixel aligned in a single row.

4. The flat panel display device as claimed in claim 1, wherein the gate lines each comprise a vertical portion and a horizontal portion.

5. The flat panel display device as claimed in claim 2, wherein each of the three pixels includes a liquid crystal cell and one or more switching elements, wherein one switching element is connected to the liquid crystal cell.

6. The flat panel display device as claimed in claim 5, wherein the first pixel and the second pixel each include:
a first switching element configured to supply an image data signal to the liquid crystal cell from the data line if turned on by the scan signal supplied to the connected gate line; and
another switching elements configured to supply the image data signal to the first switching element if turned on by a control signal supplied to one of first and the second control lines.

7. The flat panel display device as claimed in claim 6, wherein the first and the second control lines each comprise a vertical portion and a horizontal portion.

8. The flat panel display device as claimed in claim 6, wherein the switching element comprises a thin film transistor.

9. A method of driving a flat panel display device including first, second, and third pixels sharing one data line and one gate line, the method comprising:
supplying a scan signal to the gate line during a first horizontal period;
supplying first data from the data line to the first pixel by supplying a first control signal to a first control line connected to the first pixel during a first period of the first horizontal period;
supplying second data from the data line to the second pixel by supplying a second control signal to a second control line connected to the second pixel during a second period of the first horizontal period; and
supplying third data from the data line to the third pixel for the rest period of the first horizontal period.

10. The method as claimed in claim 9, wherein the first, second, and third periods of the first horizontal period substantially equally divide the first horizontal period.

11. The method as claimed in claim 9, wherein the first, second, and third pixels are respectively a red pixel, a blue pixel, and a green pixel.

12. A flat panel display device, comprising:
a plurality of pixels, each comprising a plurality of sub-pixels;
a plurality of gate lines connected to the pixels, wherein each of the sub-pixels of each of the pixels are connected to the same gate line; and
a plurality of data lines connected to the pixels, wherein each of the sub-pixels of each of the pixels are connected to the same data line.

13. The flat panel display device of claim 12, wherein each of the sub-pixels comprises:
a light control element; and
one or more switching elements configured to apply image data signals from the data lines to the light control element according to scan signals from the gate lines.

14. The flat panel display device of claim 13, further comprising a plurality of control lines, wherein the one or more switching elements of one of the sub-pixels is controlled by a control signal from one of the control lines.

15. The flat panel display device of claim 14, further comprising a plurality of control lines, wherein the one or more switching elements of another of the sub-pixels is controlled by a plurality of control signals from a plurality of the control lines.

16. The flat panel display device of claim 12, further comprising a driver configured to generate a plurality of scan signals and a plurality of image data signals, and to supply the scan signals to the gate lines and the image data signals to the data lines.

17. The flat panel display device of claim 16, further comprising a display region and a non-display region, wherein the gate and data lines are parallel to one another in the display region.

18. The flat panel display device of claim 17, wherein each of the sub-pixels comprises:
a light control element; and
one or more switching elements configured to apply image data signals from the data lines to the light control element according to scan signals from the gate lines.

19. The flat panel display device of claim 18, further comprising a plurality of control lines, wherein the one or more switching elements of one of the sub-pixels is controlled by a control signal from one of the control lines.

20. The flat panel display device of claim 19, further comprising a plurality of control lines, wherein the one or more switching elements of another of the sub-pixels is controlled by a plurality of control signals from a plurality of the control lines.
